(19) United States
(12) Patent Application Publication
(10) Pub. No.: US 2005/0004937 A1
(43) Pub. Date: Jan. 6, 2005

(54) Integrity mechanism for file transfer in communications networks

(76) Inventor: Andrew Michael Colarik, Kent, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/843,142

(22) Filed: May 11, 2004

(30) Foreign Application Priority Data
May 12, 2003 (NZ) 525794

(51) Int. Cl. G06F 7/00; G06F 17/30; G06F 17/00

(52) U.S. Cl. 707/103 X

(57) ABSTRACT

A method, a system and a computer program product for file transfer between a source node and a target node in a communications network are disclosed. The method comprises the steps of generating and storing a first hash product of a file; sending the first hash product to the target node via the communications network; receiving the first hash product as a second hash product from the target node via the communications network; generating a third hash product of the file; comparing the first, second and third hash products; and sending the file to the target node via the communications network if the first, second and third hash products match. Optionally, the method comprises the further steps of sending the matching hash product to the target node as a fourth hash product; receiving, from the target node, a result of a comparison between the second hash product, the fourth hash product and a fifth hash product generated at the target node from the file; and determining an integrity of the transferred file based on the result. The method is applicable for integration with the File Transfer Protocol (FTP).

### FIELD OF THE INVENTION

The present invention relates to communication networks and more particularly to the transfer of files in communication networks.

### BACKGROUND

The process of file transfer can be complex, particularly when transferring between diverse computing platforms connected to a modem, heterogeneous network. A determination of file integrity, by detection of any file modifications (e.g., through malicious acts, machine error or human error), is thus desirable in any file transfer process.

File Transfer Protocol (FTP) provides a means of exchanging files between two computer systems via a network and is commonly used to effect bulk file transfers between computers connected to the Internet. FTP utilises Transfer Control Protocol (TCP) coupled with a marker code inserted into the data stream for restarting a transfer when data is corrupted or the transfer is interrupted. However, FTP has no provision for detecting bits lost or scrambled in data transfer. More notably, FTP does not check the integrity of a file prior to initiating transfer of the file.

FTP uses separate control and data channels for coordinating the connections and file transfer, respectively. The Telnet protocol is employed to execute commands, thus potentially exposing control data on the control connection to eavesdropping and/or modification. This potential deficiency was addressed by Borman, D., in a document entitled “Telnet Authentication and Encryption Option”, IETF Internet-Draft, Telnet Working Group, Cray Research Inc., April 1993. Borman proposed the passing of authentication information and a mechanism to enable encryption of the data after successful authentication of the Telnet protocol. This results in user passwords not being in clear text and encryption of the data stream using any general authentication and encryption system. Disadvantageously, however, integrity protection in the absence of confidentiality is not provided.

A set of security extensions for FTP in the TCP/IP suite was proposed by Brown, Lawrie and Jaatun, Martin Gilje II, in a document entitled “Secure File Transfer Over TCP/IP”, Proceedings of IEEE Tencon-92, November 1992. The extensions provide user authentication and data encryption at various levels of security for both the control and data channels using established security mechanisms such as Public-Key Infrastructure and Kerberos through the Generic Security Services Application Program Interface (GSS-API). A significant disadvantage of the FTP security extensions is that authentication checks are performed on individual data blocks of the file, as opposed to the entire data file, thus potentially enabling insertions in the data stream that may result in file corruption. External security mechanisms are relied upon to detect or prevent insertion attacks.

Another security mechanism for FTP was proposed by Housley et al., in the document “Encryption Using KEA and SKIPJACK”, IETF RFC2773, February 2000. This proposal is that the Key Exchange Algorithm (KEA), in conjunction with the SKIPJACK symmetrical encryption algorithm, be incorporated into the FTP security extensions.

Efforts to improve FTP's security capability have generally been directed towards expanding FTP's interoperability with other protocols and security mechanisms. Grzywa et al., in a document entitled “Application-Level Survivable Software: rFTP Proof-of-Concept”, Proceedings of the 26^{th} Annual IEEE Conference on Local Computer Networks, November 2001, addresses the interruption of the FTP transfer process by providing FTP with additional features that perform at a higher level of functionality than the underlying protocols used in conjunction with FTP for this function. However, the proposed resumable-FTP does not address deliberate alteration of the data and the integrity of the file.

A need thus exists for an additional integrity mechanism for file transfer in communications networks. A need also exists for such an integrity mechanism to be integrated into the File Transfer Protocol. A further need exists for such an integrity mechanism that can assist in error detection and/or recovery.

### SUMMARY

According to a first aspect of the present invention, there is provided a method for file transfer between a source node and a target node in a communications network. The method comprises the steps of generating and storing a first hash product of a file; sending to the target node, via the communications network, the first hash product of the file; receiving from the target node, via the communications network, the first hash product as a second hash product; generating a third hash product of the file; comparing the first, second and third hash products; and sending the file to the target node, via the communications network, if the first, second and third hash products match.

The method preferably comprises the further steps of sending to the target node, via the communications network, the matching hash product as a fourth hash product; receiving from the target node, via the communications network, a result of a comparison between the second hash product, the fourth hash product and a fifth hash product generated at the target node from the file; and determining an integrity of the transferred file based on the result.

In a preferred embodiment, the method for file transfer is integrated with the File Transfer Protocol (FTP).

Another aspect of the present invention provides a system for transferring a file between a source node and a target node in a communications network. The system comprises memory for storing the file and at least one hash product generated from the file; at least one processor for generating hash products from the file and for comparing three hash products generated from the file; a transmitter for sending at least one hash product and the file to the target node; and a receiver for receiving at least one hash product from the target node. The at least one processor compares the three hash products generated from the file and the transmitter sends the file to the target node if the three hash products match.

Preferably, the three hash products comprise a first hash product generated from the file prior to a request for transfer of the file from the target node; a second hash product received from the target node; and a third hash product generated from the file after receipt of the request for transfer of the file.

Another aspect of the present invention provides an FTP-server for transferring a file to a target node in a communications network. The FTP-server comprises memory storage for storing the file and at least one hash product generated from the file; at least one processor for generating hash products from the file and for comparing three hash products generated from the file; a transmitter for sending at least one hash product and the file to the target node; and a receiver for receiving at least one hash product from the target node. The at least one processor compares the lo three hash products generated from the file and the transmitter sends the file to the target node if the three hash products match.

Yet another aspect of the present invention provides a computer program product having a computer readable medium having a computer program recorded therein for file transfer between a source node and a target node in a communications network. The computer program product includes computer program code means for generating and storing a first hash product of a file; computer program code means for sending, via the communications network, the first hash product of the file; computer program code means for receiving, via the communications network, the first hash product as a second hash product; computer program code means for generating a third hash product of the file; computer program code means for comparing the first, second and third hash products; and computer program code means for sending the file to the target node, via the communications network, if the first, second and third hash products match.

### BRIEF DESCRIPTION OF THE DRAWINGS

Embodiments of the present invention are described hereinafter, by way of example only, with reference to the accompanying drawings in which:

FIG. 1a is a process flow diagram for file transfer between nodes in a communications network;

FIG. 1b is a flow diagram of a method for file transfer between a source node and a target node in a communications network;

FIG. 2 is another flow diagram of a method for file transfer between a source node and a target node in a communications network;

FIG. 3 is a schematic block diagram of a File Transfer Protocol (FTP) system with which embodiments of the present invention can be practised;

FIG. 4 is a schematic block diagram of an alternative File Transfer Protocol (FTP) system with which embodiments of the present invention can be practised; and

FIG. 5 is a schematic block diagram of a computer system with which embodiments of the present invention can be practiced.

### DETAILED DESCRIPTION

Methods, systems and computer program products are described hereinafter that provide an integrity mechanism for file transfer in communications networks. Although certain of the embodiments are described with specific reference to the File Transfer Protocol (FTP), the system, method and computer program product described herein have general applicability to any exchange of messages over a communications network, which includes two or more nodes connected by a communications medium. The nodes can include or can be connected to a computer system such as a personal computer, a computer server, a mobile terminal, a personal digital assistant or a mobile telephone. The communications medium can typically be cable, wireless, optical (e.g. fibre optic) and/or a combination of these.

A hash product is a substantially unique bit stream, commonly of length 128 bits, that is generated from a data file. Any modifications to the data file will cause a different hash product to be generated. Collisions can occur when an identical hash product is generated from two different data files. However, a hash product generator, which usually comprises a non-linear algorithm, can be designed or selected to be collision-resistant. Examples of collision-resistant hash product generators include MD5, SHA-1 and RIPEMD-160, all of which are known in the art and have a low probability of generating a duplicate hash for a different data file.

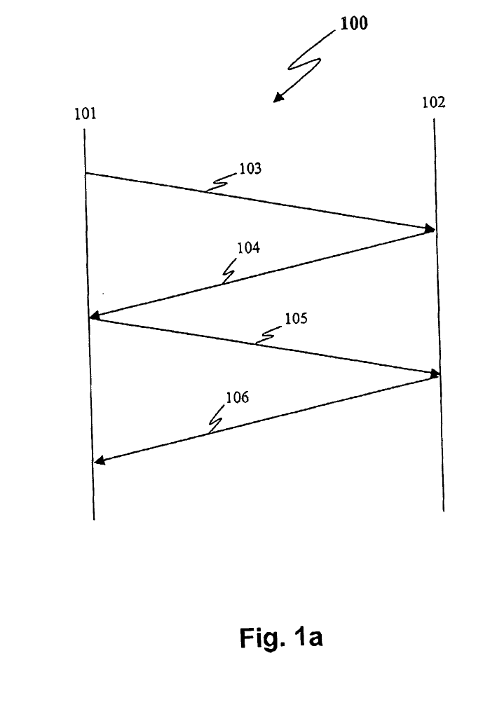

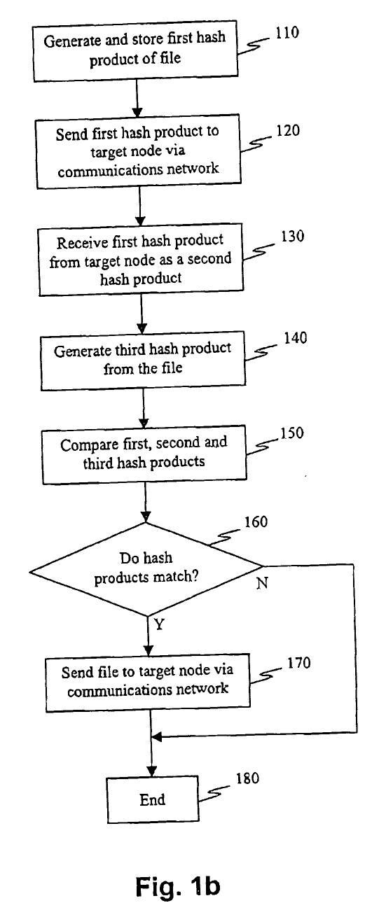

FIG. 1a shows a sequence of operations 103 to 106 for transferring a file between a source node 101 and a target node 102 in a communications network 100. Previous handshaking and security associations may occur prior to operation 103.

Prior to any transfers, a first hash product is generated from the stored file and stored in memory storage at the source node. Preferably, the first hash product is generated when the file is first created and updated whenever the file is amended.

The first hash product is sent by the source node 101 via the communications network 100, in operation 103. The first hash product is subsequently returned to the source node 101, as the second hash product, in operation 104. Then, a third hash product is generated from the file at the source node 101. The file is sent to the target node 102 if the first, second and third hash products are found to match, in operation 105.

The matching hash product can be sent together with the file, as a fourth hash product, in operation 105. The source node 101 receives a result of a comparison between the second hash product, the fourth hash product and a fifth hash product, which is generated at the target node 102 from the received file, in operation 106. The source node 101 is able to determine the integrity of the transferred file from the result of the comparison received in operation 106. The fourth hash product sent in operation 105 and operation 106 provide confirmation of integrity of the transferred file, however, operations 105 and 106 are not essential to all embodiments of the present invention. After the last operation, the session is closed.

FIG. 1b is flow diagram of a method for file transfer between source node and a target node in a communications network.

A first hash product of a file to be transferred is generated and stored at step 110. At step 120, the first hash product is sent or transmitted to the target node via the communications network.

At step 130, the first hash product sent to the target node in step 120 is received as a second hash product from the target node. A third hash product is generated from the file at step 140.

At step 150, the first, second and third hash products are compared. If the first, second and third hash products match (are all identical), the file is sent to the target node via the communications network at step 170 and the procedure terminates at step 180. Alternatively, if the first, second and third hash products do not match (N), at step 160, the procedure terminates at step 180 without the file being transferred.

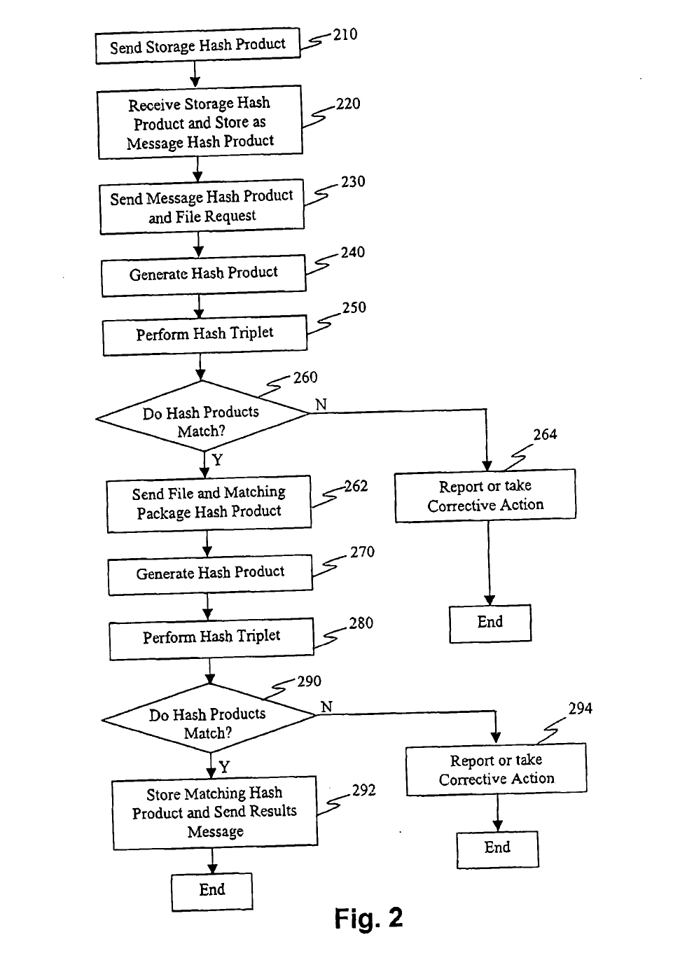

FIG. 2 is a flow diagram of a method for file transfer between a file originator 101 (the source node) and a file repository 102 (the target node) in a communications network. Prior to a file being transferred, the file is stored in a file storage system (not shown) of the source node 101, together with a hash product previously generated from the file (the storage hash product). Any subsequent modifications to the file would thus result in a different hash product to the storage hash product. Use of a unique file name further reduces the probability of a hash collision.

At step 210, the source node 101 sends a message, including the name of the file to be transferred and the storage hash product, to the target node 102. The message may be sent in response to a request (not shown) from the target node 102 to the source node 101. A nonce (counter variable) may optionally be included in the message. Successive responses or message exchanges increment the nonce, thus providing a means of identifying replay attacks.

At step 220, the message is received by the target node 102 and the message hash product (sent as the storage hash product by the source node 101) is stored in the memory (not shown) of the target node 102. The target node 102 then sends the message hash product (as the request hash product) and a request for transmission of the file to the source node 101, at step 230.

After receipt of the request hash product, a further hash product is generated at the source node 101 from the file to be sent at step 240.

At step 250, a hash triplet is performed at the source node 101, at step 250, which is a triangular comparison between the storage hash product, the request hash product and the further generated product. The results of the hash triplet enable the currency of the file to be validated prior to sending and is thus particularly useful for a software patch management system. The results of the hash triplet are used to determine the next appropriate action from Table 1.

If the storage hash, the request hash and the generated hash all match (Y), at step 260, the source node 101 sends the file and the matching storage hash product (the package hash product) to the target node 102, at step 262. If the storage hash, the message bash and the generated hash do not match (N), the appropriate corrective action from Table 1 is taken at step 264. Alternatively, non-matching of the three hash products can be reported to the source node and/or the target node and the file transfer process can be re-started or abandoned. In Tables 1 and 2, the values h₁, h₂ and h₃ represent different numerical values (i.e., hash products that do not match).

TABLE 1

| Request | Storage | Generated | |
|---|---|---|---|
| Hash | Hash | Hash | Action/Report |
| h₁ | h₁ | h₁ | Validated file, integrity confirmed, |
| | | | send file |
| h₁ | h₁ | h₂ | File changed since original message, |
| | | | original hash maybe not updated, confirm |
| | | | file integrity, regenerate hash and |
| | | | reconfirm |
| h₁ | h₂ | h₂ | Message to recipient out of date or invalid |
| | | | request, request re-transmission |
| | | | of message |
| h₁ | h₂ | h₁ | Original hash may be corrupted, update |
| | | | hash, confirm before transmitting file |
| h₂ | h₁ | h₁ | Message to recipient out of date or invalid, |
| | | | issue new notification, request re- |
| | | | transmission of file |
| h₂ | h₂ | h₁ | File changed since original message, |
| | | | original hash not updated, confirm file |
| | | | integrity, regenerate hash and reconfirm |
| h₂ | h₁ | h₂ | Original hash may be corrupted, update |
| | | | hash, confirm before transmitting file |
| h₂ | h₁ | h₃ | Discontinue file distribution, re-evaluate |
| | | | all controls |

At step 270, a further hash product is generated from the received file (the received file hash product) at the target node 102. A hash triplet is preformed at step 280, which is a triangular comparison between the package hash product, the message hash product (stored in step 220) and the received file hash product. The results of the hash triplet are used to determine the next appropriate action from Table 2.

If the package hash product, the message hash product and the received file hash product all match (Y), at step 290, the target node 102 stores the matching hash product and sends a results message to the source node 101, at step 292. Processing ends after step 292. If the package hash product, the message hash product and the received file hash product do not match (N), the appropriate corrective action from Table 2 is taken at step 294. Alternatively, non-matching of the three hash products can be reported to the source node and/or the target node and the file transfer process can be restarted or abandoned.

TABLE 2

| Package | Message | Received | |
|---|---|---|---|
| Hash | Hash | File Hash | Action/Report |
| h₁ | h₁ | h₁ | Validated file, integrity confirmed, |
| | | | store/install/execute/process file |
| h₁ | h₁ | h₂ | File changed during or after |
| | | | transmission, re-request file |
| h₁ | h₂ | h₂ | Message may be corrupted, source node |
| | | | controls may need to be examined, |
| | | | request re-transmission of message |
| h₁ | h₂ | h₁ | Original hash may be corrupted, |
| | | | message may be invalid, request |
| | | | message again and re-request file |
| h₂ | h₁ | h₁ | Message to recipient out of date or |
| | | | invalid, issue new notification, request |
| | | | re-transmission of file |
| h₂ | h₂ | h₁ | File changed since original message, |
| | | | original hash maybe not updated, |
| | | | confirm file integrity, regenerate |
| | | | hash and reconfirm |
| h₂ | h₁ | h₂ | Original hash may be corrupted, |
| | | | message may be invalid, request |
| | | | message again and re-request file |
| h₂ | h₁ | h₃ | Discontinue file distribution, re-evaluate |
| | | | all controls |

The results of the hash triplets described hereinbefore advantageously indicate a specific point of origin for the root cause of an error and thus provide the possibility of a wide range of remedies or corrective actions.

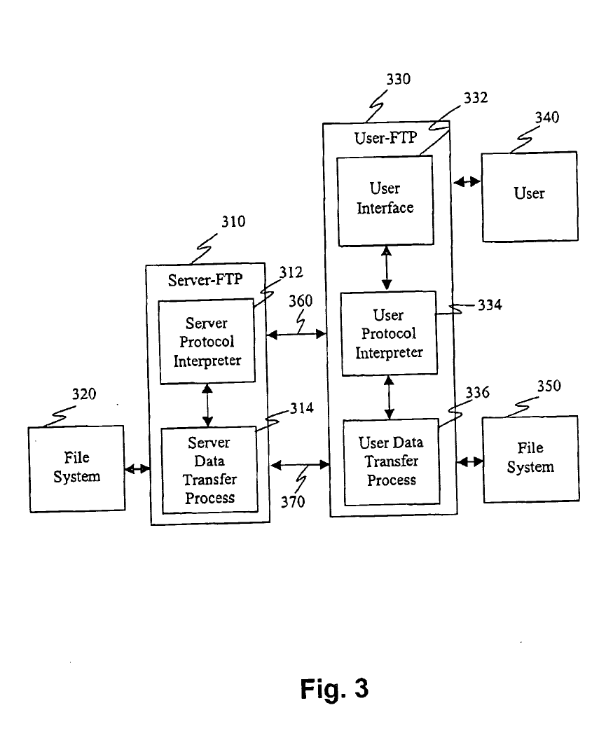

FIG. 3 is an schematic block diagram of a File Transfer Protocol (FTP) system. The components include:
a FTP Server 310, including a Server Protocol Interpreter 312 (SPI) and a Server Data Transfer Process 314;
a Server File System 320, connected to the FTP Server 310; a User Computer 330, operated by a User 340, and including a User Interface 332, a User Protocol Interpreter (UPI) 334 and a User Data Transfer Process 336; and
a User File System 350, connected to the User Computer 330.

When FTP is initiated, two separate connections or channels are established for the session. The first connection is a control connection 360 used to coordinate the connections and file transfer, whereas the second connection is a data connection 370 for transferring the file.

The UPI 334 initiates the control connection 360. FTP commands, which specify file operations and data parameters, are sent by the UPI 334 via the control connection 360 to the SPI 312. Replies from the SPI 312 to the UPI 334, which comprise a three-digit code (XYZ) accompanied by a text description of a command for the User Interface 332, are also sent via the control connection 360.

The first digit (X) of the three-digit code (XYZ) represents error code categories including: Positive Preliminary (1), Positive Completion (2), Positive Intermediate (3), Transient Negative (4), Permanent Negative (5) and Secured Reply (6). The second digit (Y) represents reply code categories including: Syntax (0), Informational (1), Connection (2), Authentication/Accounting (3), Unallocated (4) and File System (5). The third digit (Z) is a sub-designation value. An example of a SPI reply code for the case of a successful PASS (password command) being executed is “230 Password Accepted” (Positive Completion, Authentication/Accounting, command number 0). Error codes, reply codes and sub-designation values relating to the integrity mechanism can be executed by and/or assigned to unallocated values of the digits of the three-digit code.

The Server Data Transfer Process 314 and the User Data Transfer Process 336 read from and write to the Server File System 320 and the User File System 350, respectively, when transferring files. The integrity mechanism monitors the change status of the files transferred using FTP by maintaining and comparing the various hash products, which are stored in the file systems 320 and 350. The integrity mechanism is implemented as a computer software program hosted by the Server Data Transfer Process 314 and the User Data Transfer Process 336. In an alternative embodiment, the integrity mechanism can be implemented as a distinct process or function inserted between the Server Data Transfer Process 314 and the data connection 370 and between the User Data Transfer Process 336 and the data connection 370. The messages, including the hash products are transferred over the data connection 370.

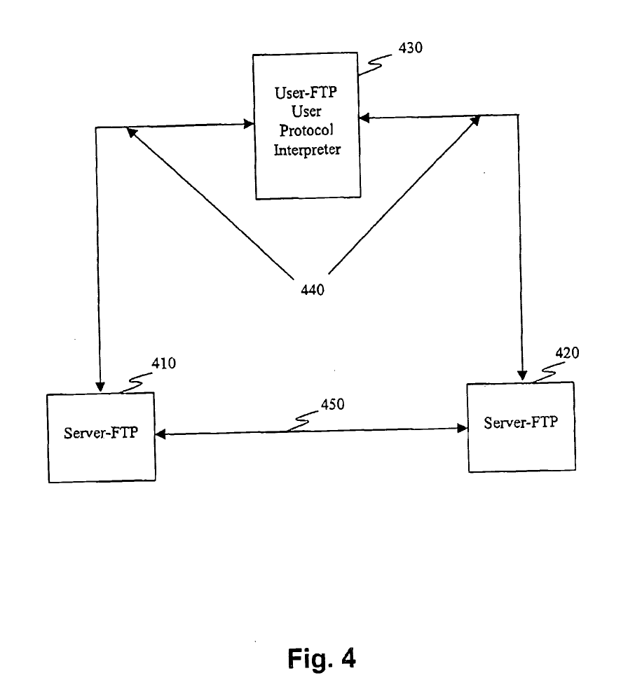

FIG. 4 is a schematic block diagram of an alternative File Transfer Protocol (FTP) system. File transfer is performed directly between two FTP servers 410 and 420 via a data connection 450. However, the control connection 440 is routed via a User Protocol Interpreter (UPI) 430, which is located remotely from the FTP servers 410 and 420. The User Protocol Interpreter (UPI) 430 may be hosted on a server located at a remote node of the communications network.

Operation of the control channel 440 by an entity other than the two FTP servers 410 and 420 requires additional protocol governance for communication via the data channel 450 and inherently requires additional coordination of source origin verification for server-to-server transfers.

The integrity mechanism monitors the change status of the files transferred using FTP by maintaining and comparing the various hash products, which are stored in the file systems (not shown) of the STP servers 410 and 420. The integrity mechanism is implemented as a computer software program hosted by the FTP servers 410 and 420. The messages, including the hash products are transferred over the data connection 450.

Computer Hardware and Software

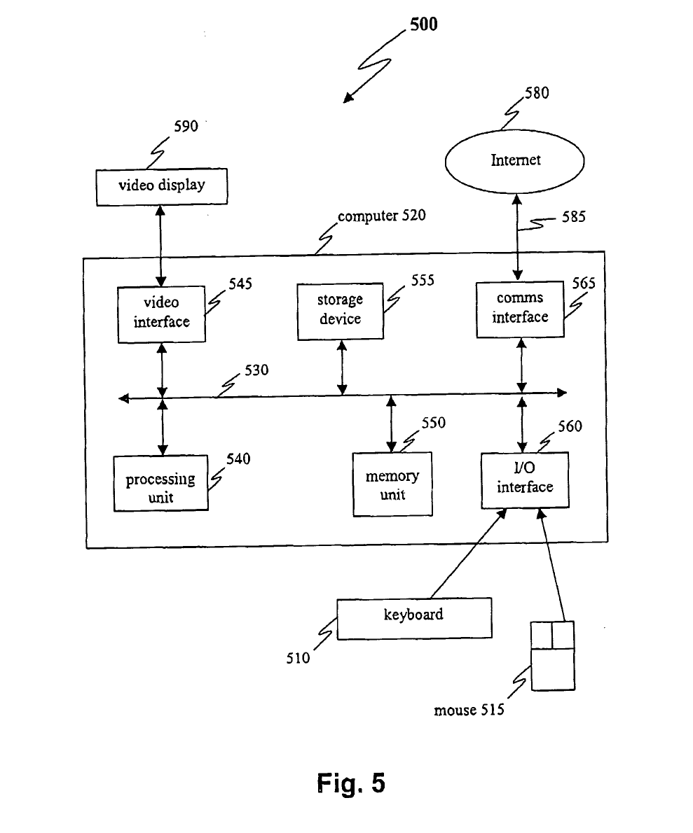

FIG. 5 is a schematic representation of a computer system 500 that can be used to perform steps the methods described herein. For example, a computer system 500 can be located at one or more of the source, remote and target nodes. The computer system 500 is provided for executing computer software that is programmed to assist in performing the described techniques. The computer software executes under a suitable operating system installed on the computer system 500 such as Microsoft Windows or Linux.

The computer software involves a set of programmed logic instructions that are able to be interpreted by the computer system 500 for instructing the computer system 500 to perform predetermined functions specified by those instructions. The computer software may be an expression recorded in any language, code or notation, comprising a set of instructions intended to cause a compatible information processing system to perform particular functions, either directly or after conversion to another language, code or notation.

The computer software is programmed by a computer program comprising statements in an appropriate computer language. The computer program is processed using a compiler into computer software that has a binary format suitable for execution by the operating system. The computer software is programmed in a manner that involves various software components, or code means that perform particular is steps in the process of the described techniques.

The components of the computer system 500 include a computer 520, input devices 510, 515 and video display 590. The computer 520 includes a processing unit 540, a memory unit 550, a communicators interface 565, an input/output (I/O) interface 560, a video interface 545, and a storage unit 555.

The processing unit 540 may comprise one or more central processing units (CPUs) that execute the operating system and the computer software under the operating system. The memory unit 550 may include random access memory (RAM), read-only memory (ROM), flash memory and/or any other type of memory known in the art. The memory unit 550 is used under control of the processing unit 540.

The video interface 545 is connected to the video display 590 and provides video signals for display on the video display 590. User input to operate the computer 520 is provided from input devices 510, 515 comprising a keyboard 510 and a mouse 515. The storage unit 555 may include a disk drive or any other suitable non-volatile storage medium known in the art.

Each of the components of the computer 520 is connected to a bus 530 that includes data, address, and control buses, to allow these components to communicate with each other via the bus 530.

The computer system 500 can be connected to one or more other similar computers via a communications interface 565 using a communication channel 585 to a network 580, represented as the Internet. The communications interface 565 may comprise a transmitter and a receiver, which may comprise a modulator/demodulator (modem) for transmitting and receiving data to/from the communications channel 585.

The computer software program may be provided as a computer program product, and recorded on a portable storage medium. In this case, the computer software program is accessed by the computer system 500 from the storage device 555. Alternatively, the computer software can be accessed directly from the network 580 by the computer 520. In either case, a user can interact with the computer system 500 using the keyboard 510 and mouse 515 to operate the programmed computer is software executing on the computer 520.

The computer system 500 is described for illustrative purposes and other configurations or types of computer systems can equally well be used to practice the methods described herein. The computer system 500 represents only one example of a particular type of computer system suitable for practicing the described techniques.

Computer software or source code written in the Java programming language that implements an integrity mechanism for file transfer in communications networks is included in Table 3, included in this document hereinafter. The software uses a CORBA compliant object request broker provided in the Java 2 Platform Standard Edition Development Kit version 1.4, which is widely portable between various computing platforms. The hash generator used in the source code is based on the 128-bit message digest MD5 model developed by Ronald Rivest in 1992, The source code includes comments to aid readability.

Further detail concerning the MD5 model can be obtained from the document “The MDS Message-Digest Algorithm”, Rivest, R. L., IETF RFC1321, April 1992, which is incorporated herein in its entirety by reference.

Further detail concerning the File Transfer Protocol (FTP) can be obtained from the document “File Transfer Protocol (TP)”, Postel, J. and Reynolds, J., IETF STD9, RFC959, October 1985, which is incorporated herein in its entirety by reference.

The methods, systems and computer program products described hereinbefore provide an integrity mechanism for file transfer in communications networks. Various alterations and modifications will be apparent to those skilled in the relevant art, in light of the foregoing description. The present invention, in its broadest aspects, is thus not limited by the foregoing description but rather by the scope of the appended claims.

```
TABLE 3
import FileRepository.*; // The package containing our stubs.
import org.omg.CosNaming.*; // HelloClient will use the naming service.
import org.omg.CORBA.*; // All CORBA applications need these classes.
import java.io.*;
import java.security.*;
public class FileRepositoryClient
{
  private static final String hex = “0123456789ABCDEF”;
  private static String fileDirName =
“ClientCache”+File.separatorChar+“File”+File.separatorChar;
  private static String hashDirName =
“ClientCache”+File.separatorChar+“Hash”+File.separatorChar;
  private static String fileName = “”;
  public static void main(String args[]){
  new FileRepositoryClient(args):
  }
  public FileRepositoryClient(String args[]){
  try{
  System.out.printIn(“ORB initialising...\n”):
  // Create and initialize the ORB
  ORB orb = ORB.init(args, null);
  // Get the root naming context
  org.omg.CORBA.Object objRef = orb.resolve_initial_references(“NameService”);
  NamingContext ncRef = NamingContextHelper.narrow(objRef);
  // Resolve the object reference in naming
  NameComponent nc = new NameComponent(“FileManager”, “ ”);
  NameComponent path[] = {nc};
  FileManager fileManager = FileManagerHelper.narrow(ncRef.resolve(path));
  /** Read the name of the file to be transfered from the user.
  *
  */
  getFileName( );
  System.out.printIn(“Sending request...\n”):
  /** Read primary hash from the local cache
  *
  */
  String requestHash = readFile(hashDirName+fileName+“.hash”);
  /** Send fileName and primary hash to the server. The server sends back
acknowledgement
  * using the hash product. Save it as storage hash for client side.
  */
  String storageHash = fileManager.sendRequestHash(fileName, requestHash);
  /** Generate a new hash product from the file stored in the local cache.
  *
  */
  String generatedHash = getHashProduct(fileDirName+fileName);
  //System.out.printIn(“request hash: ”+requestHash+“\nstorage hash:
”+storageHash+“\ngenerated hash: ”+generatedHash);
  //System.out.printIn(“request hash: ”+requestHash.length( )+“\nstorage hash:
”+storageHash.length( )+“\ngenerated hash: ”+(generatedHash.trim( )).length( ));
  //System.out.printIn(“request hash equals to storage hash:
”+requestHash.equals(storageHash));
  System.out.printIn(“Comparing hash triplet...\n”);
  /** Compare three hash products. If anything wrong, retransmit the file
  *
  */
  String message = getMessage(lookupTable(requestHash.trim( ), storageHash.trim( ),
generatedHash.trim( )));
  If (Imessage.startsWith(“A.”)){
    System.out.printIn(“Errors with file transfer: ”+message);
    System.exit(−1);
  }
  else
  System.out.printIn(message);
  System.out.printIn(“\nSending file package...\n”);
  /** Read the content of the file from the local cache, and send it along with the
  * generated hash product to the server. The server replies with a message indicating
  * if the file transfer is successful or not.
  */
  String f_content = readFile(fileDirName+fileName);
  message = fileManager.sendFileAndStorageHash(f_content, generatedHash):
  // Display message.
  System.out.printIn(“Message from the File Repository Server: \n”+message);
  }
  catch(Exception e) {
  System.out.printIn(“ERROR : ” + e);
  e.printStackTrace(System.out);
  }
  }
  /** Get the file name from the user using the keyboard.
  * Return the file name as a string.
  */
  private void getFileName( ){
  while(true){
  System.out.printIn(“Getting file name...\n”);
  //Get user name and password from the user input
  String userFileName = “”;
  System.out.print(“<Type q or Q to quit>\nEnter the name of the file to be transfered: ”);
  userFileName = getUserInput( );
  if (userFileName.equalsIgnoreCase(“q”))
    System.exit(0);
  File userFile = new File(fileDirName+userFileName);
  if (userFile.isFile( )){
    fileName = userFileName;
    return;
  }
  else{
    fileName = “”;
    System.out.printIn(“Invalid file name. Try again.\n”);
  }
  }
  }
  /**
  * Read the input from the user through keyboard and return it
  *
  * @return a <code>String</code> of the user input
  **/
  private static String getUserInput( ){
  try{
  BufferedReader br = new BufferedReader(new InputStreamReader(System.in));
  return br.readLine( );
  }
  catch(IOException e){}
  return “”;
  }
  // Calculate the hash value for the given file
  private static String getHashProduct(String file_name){
  byte buf[] = new byte[1024]; // read buffer for file & MD5's
  // Set up the java.security MD5 & it's digest result
  MessageDigest smd = null;
  try {
  smd = MessageDigest.getInstance(“MD5”):  // java.security MD5
  byte sdg[] = new byte[6];
  } catch (NoSuchAlgorithmException nsae) {
  System.out.printIn(“Can't find MD5”);
  System.exit(1);
  }
  byte sdg[];
  // Open a file and loop until EOF - calculating the MD5.
  try {
  RandomAccessFile ri = new RandomAccessFile(file_name, “r”);
  int bcount;
  while ((bcount = ri.read(buf)) > 0){
  smd.update(buf, 0, bcount):
  }
  ri.close( );
  } catch(Exception e) {
  System.out.printIn(“Can't read file: ” + fileName + “ -> ” + e);
  System.exit(1):
  }
  // For a bit of fun we can see how sensitive the algorithm is
  // by adding one more byte. Usually there is no match at all
  // even with one byte off. Uncomment this only if you want to
  // see this action.
  // smd.update(buf, 0, 1);
  sdg = smd.digest( );
  return hexString(sdg);
  }
  // Convert bytes into a hex string.
  //
  private static String hexString(byte [] vb){
  StringBuffer sb = new StringBuffer( );
  for (int j = 0; j < vb.length; j++){
  sb.append(hex.charAt((int)(vb[j] >> 4) & 0xf));
  sb.append(hex.charAt((int)(vb[j]) & 0xf));
  sb.append(‘ ’);
  }
  return sb.toString( ):
  }
  // Read the content from the given file, and return it as a string
  private static String readFile(String file_name){
  String s = “”;
  try{
  BufferedReader in = new BufferedReader(new FileReader(file_name));
  int c = in.read( ):
  while (c != −1){
  s+=(char)c:
  c=in.read( ):
  }
  in.close( ):
  }catch(Exception e){
  System.out.printIn(“Can't read from file: ”+e.getMessage( ));
  }
  return s;
  }
  // write the string value to a give file
  private static void writeToFile(String file_name, String s){
  try{
  PrintWriter out = new PrintWriter(new FileOutputStream(file_name));
  out.write(s);
  out.close( );
  }catch(Exception e){
  System.out.printIn(“Can't write to file: ”+e.getMessage( ));
  }
  }
  /** Look up the corresponding message through the table entry.
  * Return the message as a string object.
  */
  private String getMessage(int entry){
  switch(entry){
  case 0:
  return “A. Validated file, integrity confirmed, send file...”:
  case 1:
  return “B. File has changed since original message, ” +
    “original hash may not have been updated, ” +
    “confirm file integrity before continuing, ” +
    “regenerate hash and reconfirm.”;
  case 2:
  return “C. Message to Recipient is invalid or out of date, ” +
    “may be an invalid request, request retransmission of message.”;
  case 3:
  return “D. Original hash may be corrupted. Update hash file, confirm before transmitting
  file.”;
  }
  return “”;
  }
  /** Compare three hash products.
  * Return an int value representing the comparing result, which can be used as
  * the table entry to look up a corresponding message.
  */
  private int lookupTable(String requestHash, String storageHash, String generatedHash){
  int entry = −1;
  If (requestHash.equals(storageHash) && storageHash.equals(generatedHash))
  entry = 0;
  else if (requestHash.equals(storageHash) && !storageHash.equals(generatedHash))
  entry = 1;
  else if (IrequestHash.equals(generatedHash) && IstorageHash.equals(requestHash))
  entry = 2;
  else if (requestHash.equals(generatedHash) && !storageHash.equals(generatedHash))
  entry = 3;
  else
  entry = −1;
  return entry;
  }
}
```

1. A method for file transfer between a source node and a target node in a communications network, said method comprising the steps of:
generating and storing a first hash product of a file;
sending to said target node, via said communications network, said first hash product of said file;
receiving from said target node, via said communications network, said first hash product as a second hash product;
generating a third hash product of said file;
comparing said first, second and third hash products; and
sending said file to said target node, via said communications network, if said first, second and third hash products match.

2. The method of claim 1, comprising the further steps of:
sending to said target node, via said communications network, said matching hash product as a fourth hash product;
receiving from said target node, via said communications network, a result of a comparison between said second hash product, said fourth hash product and a fifth hash product generated at said target node from said file; and
determining an integrity of said transferred file based on said result.

3. The method of claim 2, wherein:
the comparison of said first, second and third hash products is performed at said source node; and
the comparison of said second, fourth and fifth hash products is performed at said target node.

4. The method of claim 1, comprising the further step of performing a corrective action if any of said first, second and third hash products are found to be different, wherein said corrective action is selected from the group of corrective actions consisting of:
regenerating said third hash product if said first and second hash products are the same but are different to said third hash product;
resending said first hash product if said second and third hash products are the same but are different to said first hash product; and
requesting and re-receiving said second hash product if said first and third hash products are the same but are different to said second hash product.

5. The method of claim 2, comprising the further step of performing a corrective action if any of said second, fourth and fifth hash products are found to be different, wherein said corrective action is selected from the group of corrective actions consisting of:
resending said file to said target node if said second and fourth hash products are the same but are different to said fifth hash product,
resending said fourth hash product if said second and fifth hash products are the same but are different to said fourth hash product; and
resending said file and said fourth hash product if said fourth and fifth hash products are the same but are different to said second hash product.

6. The method of claim 1, when integrated with the File Transfer Protocol (FTP).

7. The method of claim 2, when integrated with the File Transfer Protocol (FTP).

8. A system for transferring a file between a source node and a target node in a communications network, the system comprising:
memory for storing said file and at least one hash product generated from said file;
at least one processor for generating hash products from said file and for comparing three hash products generated from said file;
a transmitter for sending at least one hash product and said file to said target node; and
a receiver for receiving at least one hash product from said target node;
wherein said at least one processor compares said three hash products generated from said file and said transmitter sends said file to said target node if said three hash products match.

9. The system of claim 8, wherein said three hash products comprise:
a first hash product generated from said file prior to a request for transfer of said file from said target node;
a second hash product received from said target node; and
a third hash product generated from said file after receipt of said request for transfer of said file.

10. The system of claim 8, wherein:
said transmitter sends said matching hash product to said target node;
said receiver receives a result of a comparison of three hash products performed at said target node, wherein at least one of said three hash products is generated from said transferred file at said target node; and
said processor determines an integrity of said transferred file based on said result.

11. An FTP-server for transferring a file to a target node in a communications network, the FTP-server comprising:
memory storage for storing said file and at least one hash product generated from said file;
at least one processor for generating hash products from said file and for comparing three hash products generated from said file;
a transmitter for sending at least one hash product and said file to said target node; and
a receiver for receiving at least one hash product from said target node;
wherein said at least one processor compares said three hash products generated from said file and said transmitter sends said file to said target node if said three hash products match.

12. The FTP-server of claim 8, wherein:
said transmitter sends said matching hash product to said target node;
said receiver receives a result of a comparison of three hash products performed at said target node, wherein at least one of said three hash products is generated from said transferred file at said target node; and
said processor determines an integrity of said transferred file based on said result.

13. A computer program product having a computer readable medium having a computer program recorded therein for file transfer between a source node and a target node in a communications network, said computer program product including:
computer program code means for generating and storing a first hash product of a file;
computer program code means for sending, via said communications network, said first hash product of said file;
computer program code means for receiving, via said communications network, said first hash product as a second hash product;
computer program code means for generating a third hash product of said file;
computer program code means for comparing said first, second and third hash products; and
computer program code means for sending said file to said target node, via said communications network, if said first, second and third hash products match.

14. The computer program product of claim 13, further comprising:
computer program code means for sending, via said communications network, said matching hash product as a fourth hash product;
computer program code means for receiving, via said communications network, a result of a comparison between said second hash product, said fourth hash product and a fifth hash product generated at said target node from said file; and
computer program code means for determining an integrity of said transferred file based on said result.

15. The computer program product of claim 13, farther comprising computer program code means for performing a corrective action if any of said first, second and third hash products are found to be different, wherein said further computer program code means is selected from the group of computer program code means consisting of:
computer program code means for regenerating said third hash product if said first and second hash products are the same but are different to said third hash product;
computer program code means for resending said first hash product if said second and third hash products are the same but are different to said first hash product; and
computer program code means for requesting and re-receiving said second hash product if said first and third hash products are the same but are different to said second hash product.

16. The computer program product of claim 14, further comprising computer program code means for performing a corrective action if any of said second, fourth and fifth hash products are found to be different, wherein said further computer program code means for corrective action is selected from the group of computer program code means consisting of:
computer program code means for resending said file to said target node if said second and fourth hash products are the same but are different to said fifth hash product;
computer program code means for resending said fourth hash product if said second and fifth hash products are the same but are different to said fourth hash product; and
computer program code means for resending said file and said fourth hash product if said fourth and fifth hash products are the same but are different to said second hash product.
